(19) United States
(12) Patent Application Publication
(10) Pub. No.: US 2009/0155416 A1
(43) Pub. Date: Jun. 18, 2009

(54) Fermented Appetence Factors Without Animal Proteins for Animals

(76) Inventors: Aurelie De Ratuld, Ploeren (FR); Remi Thiriot, Lizio (FR); Isabelle Guiller, Le Tour Du Parc (FR)

Correspondence Address: BIRCH STEWART KOLASCH & BIRCH, PO BOX 747, FALLS CHURCH, VA, 22040-0747, US

(21) Appl. No.: 11/990,215

(22) PCT Filed: Jul. 20, 2006
(86) PCT No.: PCT/EP2006/064474

§ 371 Date: Feb. 8, 2008

(30) Foreign Application Priority Data
Aug. 9, 2005 (FR) 0508451

(51) Int. Cl. A23K 1/16

(52) U.S. Cl. 426/60; 426/62

(57) ABSTRACT

The invention relates to appetence factors for animal feeding. More specifically, the invention relates to an appetence factor for animal feeding, obtained by fermentation with the aid of a yeast and which comprises at least one, in the absence of protein constituents of animal origin: a humidity (H) ranging from approximately 80 to 96% by weight; a protein fraction (FP) ranging from approximately 1.5 to 10.0% by weight; fat (MG) up to approximately 10%; sugars (S) ranging from approximately 0.20 to 2.0% by weight, and ashes (C) ranging from approximately 0.3 to 8.0% by weight.

The present invention relates to the field of palatability factors for animal feeding.

More specifically, the present invention relates to a palatability factor for animal feeding, obtained by fermentation with the aid of yeast and which comprises at least, in the absence of protein constituents of animal origin:
humidity (H): from 80 to 96% by weight approximately;
protein factor (FP): from 1.5 to 10.0% by weight approximately;
fatty matter (MG): up to 10% by weight approximately;
sugars (S): from 0.20 to 2.0% by weight approximately;
ashes (C): from 0.3 to 8.0% by weight approximately.

By way of the food given to animals, especially to pets, the attempt is made to foster and preserve their health, their wellbeing and their equilibrium. However, even the most beneficial food from the nutritional viewpoint are of no interest if the animal rejects it or refuses to eat it, or even if the rations taken by the animal are small because the food is not sufficiently to its taste.

Also, to make it easier for animals to take their food, and more particularly domesticated animals such as dogs and cats which often prove difficult, the attempt has been made from early on to improve the palatability of foods, while preserving their nutritional qualities.

Typically, meat and fish represent the principal sources of protein in the majority of animal food. In fact, the nature and quantity of amino acids contributed by animal derivatives (meat, bone, fish) give the foods the expected nutritional qualities. Furthermore, the effect these derivatives have is to augment the palatability of the food which they contain.

However, the presence of constituents of animal origin in the foodstuffs considerably raises their retail cost.

This is why research was very quickly aimed at developing food and nutritionally balance food ingredients as appetising as traditional food and ingredients based on animal content (for example, based on liver), though prepared less costly. In fact, the animal feed industry has quickly measured the interest in finding sources of stable proteins, nutritionally satisfying and, above all, economical, for substituting them with meat or fish during preparation of food and food ingredients for animals.

In this context, U.S. Pat. No. 4,039,687 (in the name of Weyn) proposes substituting all or part of the animal protein present in the food by synthetic proteins obtained from fermenting micro-organisms, e.g., bacteria or yeasts. The resulting food has satisfactory palatability properties and can be made at less cost relative to food based on natural proteins of animal or vegetable origin. In practice, the biomass obtained after fermentation of micro-organisms on hydrocarbons is incorporated into the food as a source of protein.

U.S. Pat. No. 4,800,093 (in the name of Hogan et al.) describes a food product for animals with a high humidity rate, in which a proportion of the initial meat meal is replaced by the biomass obtained after fermentation of filamentous fungi on inexpensive substrates such as soy whey.

British patent application GB 2 385 767 (in the name of Norferm DA) took an interest in methanotrophic bacteria cultures such as palatability factors. The biomass utilised is obtained by fermentation of a bacterium of the type Methylococcus capsulatus on hydrocarbons or natural gas.

Therefore, according to the prior art, it is possible to substitute animal proteins, without prejudice to palatability, with the nutritional qualities of prepared food, proteins synthesised by micro-organisms, added to food in the form of a biomass obtained after fermentation.

However, adding a biomass to animal feed as a palatability factor is not without its drawbacks, especially since such an ingredient necessarily entails (i) efficacious an inactivation step of the biomass, so as to prevent any unexpected modification to the organoleptic properties of the food to which it will be added (due, for example, to fermentation or undesirable growth of micro-organisms); and (ii) a separation step for eliminating the fermentation medium. Also, such an ingredient often has a tendency to modify the appearance (e.g., the colour) of the resulting food.

So there is a need for palatability factors for animals, which are all: (i) balanced in terms of nutrition and calories; (ii) at least as efficacious as conventional factors based on animal derivatives; (iii) easy to prepare, from primary materials easily accessible and economical; (iv) stable over time; and (v) as neutral as possible in terms of their physical properties (colour, viscosity, etc.), so as to both not modify the appearance and texture of the food to which they are added and so as not to create particular use difficulties (for example, in the event of pulverisation on the food).

Within the scope of the present invention the Applicant proposes a palatability factor for animals which compensates, as satisfactorily as surprisingly, for the existing need in this field. As illustrated in the detailed description and examples herein below, (1) the palatability factor according to the invention is nutritionally balanced; (2) it is a vegetarian and hypoallergenic product; (3) it is more efficacious than traditional palatability factors based on proteins of animal origin; (4) it is easily obtained by fermentation of microorganisms, preferably yeasts; (5) surprisingly the fermentation medium itself is used as palatability factor, allowing one of the steps required for producing the palatability factors of the prior art based on biomass to be omitted, since, according to the invention, either the fermentation medium is used alone—it suffices to leave out the biomass and the inactivation step becomes superfluous—, or the fermentation medium is used in the presence of the biomass—it is a simple matter of efficaciously inactivating the biomass; (6) its physical properties are neutral overall: it is an aqueous liquid, clear in colour, which easily melts in a mass; (7) it is easy to use, especially by application, pulverisation, incorporation, impregnation.

In terms of the invention, an <<palatability factor>> (or equally an “palatability agent”, an “appetizing” or “palatable factor”) for animals is a factor whereof the organoleptic properties. (perfume, taste, appearance, texture, etc.) are such that an animal will experience the desire to absorb it. Within the scope of the present invention, a palatability factor is most often a food ingredient (or additive) added to animal feed. But, by extension, this can likewise be a foodstuff, even a drink, containing such an ingredient.

Thus, a first aspect of the present invention relates to a fermented palatability factor to be added to animal feed, characterised in that it comprises the fermentation medium obtained after culture of at least one yeast, said fermentation medium containing at least:

humidity (H): from 80 to 96% by weight approximately;

protein factor (FP): from 1.5 to 10.0% by weight approximately;

fatty matter (MG): up to 10% by weight approximately;

sugars (S): from 0.20 to 2.0% by weight approximately; and

ashes (C): from 0.3 to 8.0% by weight approximately, where said protein factor FP is devoid of constituents of animal origin.

For example, particular palatability factors will comprise at least, in the absence of protein constituents of animal origin:
humidity (H): from 85 to 96% by weight approximately;
protein factor (FP): from 1.5 to 10.0% by weight approximately;
fatty matter (MG): up to 1% by weight approximately;
sugars (S): from 0.20 to 2.0% by weight approximately; and
ashes (C): from 0.3 to 8.0% by weight approximately; or
humidity (H): from 90 to 96% by weight approximately;
protein factor (FP): from 2.5 to 10.0% by weight approximately;
fatty matter (MG): up to 5% by weight approximately;
sugars (S): from 0.30 to 0.75% by weight approximately; and
ashes (C); from 0.5 to 0.7% by weight approximately; or again
humidity (H): from 90 to 96% by weight approximately;
protein factor (FP): from 2.5 to 10.0% by weight approximately;
fatty matter (MG): up to 1% by weight approximately;
sugars (S): from 0.30 to 0.75% by weight approximately; and
ashes (C): from 0.5 to 0.7%,by weight approximately.

The term <<ashes>> in this case designates the mineral material following calcination of the product.

“Fatty matter” is understood here to mean any type of fatty matter adapted to animal food and likely to be metabolised (that is, likely- to be consumed or produced) by the micro-organism responsible for fermentation at the origin of the palatability factor. This can be fatty matter of animal or vegetable origin or a combination thereof. The expert will know which type(s) of fatty matter to use as a function of his general knowledge and applications of the palatability factor envisaged.

The constituents of the FP protein factor can be proteins, peptides, amino acids, and combinations thereof. The terms “proteins” and “peptides” could sometimes be utilised indifferently in the following, given that the expert is capable of determining the exact sense to be given to one or the other of these terms according to context and the light of his general knowledge. Furthermore, the expressions <<protein constituents>> and “constituents of the FP protein factor” are equivalent here.

According to an embodiment, the protein factor FP comprises at least 90% by weight approximately of one or more amino acids selected from alanine, threonine, lysine and sulphured amino acids. In particular, the FP protein factor comprises at least 95%, preferably at least 98%, preferably again at least 99% by weight approximately of said amino acids.

This or these amino acids are preferably selected from sulphured amino acids, such as methionine and cystein. It is preferred to use methionine.

According to another embodiment, a palatability factor according to the invention has a pH ranging from 1.6 to 3.5 approximately, given that a pH ranging from 2.6 to 3.2 approximately is preferred.

A palatability factor according to the invention is “fermented”, that is, it is obtained by fermentation using at least one micro-organism, which is, within the scope of the invention, yeast. Preferably, the yeast is selected from Yarrowia sp., Saccharomyces sp., Candida sp., Kluyveromyces sp., Pichia sp., Debaryomyces sp., Zygosaccharomyces sp. More preferably, the yeast is selected from Yarrowia lipolytica, Saccharomyces cerevisiae, Candida versalitis, Kluyveromyces lactis, Kluyveromyces fragilis, Pichia pastoris, Debaryomyces harsenii, Zygosaccharomyces rouxii. Yarrowia lipolytica yeast is preferred most of all.

As indicated hereinabove, a palatability factor according to the invention comprises the fermentation medium obtained after culture of said yeast. Optionally, the fermentation medium is utilised as palatability agent after having been stripped of the biomass.

According to yet another embodiment, the palatability factor is in a ready-to-use liquid form. Alternatively, it can serve as intermediary product in the preparation of a concentrated fermented palatability factor. In this case, the concentrated palatability factor, at a reduced humidity rate, can be in liquid form or in dehydrated form. “Concentrated” is understood to designate a palatability factor obtained by concentration of a palatability factor having the H, FP, MG, S and C contents described hereinabove. It is obvious that the concentrated palatability factor has, due to the same fact of concentration, FP, MG, S and C contents higher than those specified hereinabove, at the same time having a lower humidity rate.

According to an embodiment, a palatability factor of the invention is applied to animal feed. Alternatively, the palatability factor is incorporated into animal feed. In general, this is “adding” or “using” a palatability factor. “Adding” or “using” a palatability factor includes the notion of “applying the factor to”, that is, adding it to the surface, for example by pulverisation or coating, and the notion of “incorporating the factor in”, that is, adding it to the mass, for example by impregnation or mixing.

“Animal feed” here designates one or more foodstuffs for animals. It can be solid matter (e.g., croquettes), liquids (e.g., broths, drinks), or more or less moist intermediary products (e.g., soups, paps, pellets, pates, etc.). As a function of context, it could likewise be a food ration or a meal, making reference to all food (without differentiating) taken during the course of a meal, or even over a time period such as a day or longer.

The terms “for animals” or “animal(s)”, must be taken in their widest sense as referring to animals of all types. The palatability factors according to the invention, or the animal feed to which they are added, are preferably made for pets such as dogs and cats, and a particular preference for dogs. However, the object of the invention addresses any animal likely to be domestic or tame or bred, for example, birds, rabbits, rodents, fish, etc. These can likewise be reared animals such as pigs, poultry, cattle, fish, crustaceans, etc. . . .

According to another embodiment, a palatability factor according to the present invention is used in association with one or more other palatability factors such as palatability factors of animal and/or vegetable origin.

According to yet another embodiment, the palatability factor forming the object of the invention is used at a rate of 1 to 10% by weight approximately, preferably at a rate of 2 to 4% by weight approximately.

A second aspect of the present invention relates to a concentrated fermented palatability factor likely to be obtained by concentration and/or dehydration of at least one palatability factor such as described hereinabove.

According to a third aspect, the present invention relates to a composition of palatability factors to be added to animal feed, comprising at least one palatability factor as mentioned hereinabove. Such a composition can comprise only palatability factors according to the present invention, or else likewise comprise one or more palatability factors of animal and/or vegetable origin.

In a fourth aspect, the present invention relates to a method for preparation of a palatability factor according to the preceding description, said method comprising at least the following steps:

a) preculture of at least one yeast such as described hereinabove in a standard growth medium, at a temperature ranging from 22° C. to 32° C. approximately, for 6 to 25 hours approximately;

b) seeding a fermentation medium containing one or more amino acids, by means of said preculture at a rate of at least 1.10⁵ cells/ml approximately;

c) culture of the seeded fermentation medium for 12 to 72 hours approximately, at a temperature ranging from 20° C. to 32° C. approximately;

d) termination of fermentation; and

e) recovery of the final fermentation medium, useful as palatability factor.

According to particular embodiments, whereof it is optionally possible to combine one or more characteristics:

the preculture step a) is carried out at a temperature of 30° C. approximately;

the preculture step a) is maintained for 8 to 16 hours approximately;

the culture step c) is maintained for 12 to 60 hours approximately, or for 12 to 55 hours approximately, or even for 20 to 72 hours approximately, or better still for 30 to 50 hours approximately;

the culture step c) is carried out at a temperature ranging from 28° C. to 30° C. approximately.

In particular, the preculture will be maintained up to completion of the exponential growth phase of the yeast.

By way of advantage, the standard growth medium utilised for the preculture comprises extracts of yeast, malt and sugars such as glucose. It can further comprise peptone and/or oligoelements. For example, this medium can be a Yeast Malt (YM) medium, known to the expert.

According to an embodiment, the fermentation medium utilised in step b) comprises approximately 2 to 10% by weight, preferably approximately 3 to 5% by weight, of one or more amino acids. These amino acids are preferably amino acids suitable metabolising by yeast. Alternatively, among the amino acids present in the fermentation medium there can be amino acids suitable for metabolising by yeast and non-metabolised amino acids, added as supplements. If necessary, these supplementary amino acids can have a positive effect on the palatability of the factor obtained, for example by improving its organoleptic properties. The proportions of the different amino acids can vary, with a preference for a preponderance of amino acids to be metabolised. The latter are especially selected from alanine, threonine, lysine and sulphured amino acids. This or these amino acids are preferably selected from sulphured amino acids, such as methionine and cystein. Methionine is preferably used.

According to another embodiment, the fermentation medium utilised in step b) further comprises up to 10% by weight, approximately, preferably between 5 and 10% by weight approximately, of fatty matter.

According to yet another embodiment, the fermentation medium utilised in step b) further comprises extracts of yeast and malt.

According to preferred embodiments, the seeding of the fermentation medium using the preculture (step b) is carried out at a rate at least equal to, in ascending order preferably, 5.10⁵, 1.10⁶, 4.10⁶, 6.10⁶ cells/ml approximately, so a to attain a cellular population at the start of growth culture of at least 5.10⁵, 1.10⁶, 4.10⁶, 6.10⁶ cells/ml approximately in the fermentation medium.

According to an embodiment, the pH of the fermentation medium is adjusted at the start of step c) at a value ranging from 4.5 to 6.5 approximately, preferably from 5.4 to 5.8 approximately.

According to yet another embodiment, the preculture of step a) is carried out in aeration conditions ranging from 0.5 to 1.5 vvm approximately; and/or the culture of step c) is carried out in aeration conditions ranging from 0.02 to 0.40 vvm approximately.

According to yet another embodiment, the preculture of step a) and/or said culture of step c) is (are) maintained under agitation.

According to the method object of the invention, since the palatability factor is constituted by the final fermentation medium the biomass could be omitted, or the final fermentation medium comprising the biomass could be kept, which would then be inactivated. Therefore, prior to step e), the fermentation medium can be stripped of the biomass, preferably by a separation technique selected from filtration, decantation, centrifuging. Alternatively, steps d) to e), including the biomass elimination step, could be carried out simultaneously, preferably by sterilising filtration. Or, if the biomass is not eliminated, step d) could for example be carried out by thermal inactivation of yeasts.

A fifth aspect of the present invention relates to a method for improving the palatability of animal feed, which comprises adding to the animal feed at least one palatability factor or at least one composition as described earlier.

In particular, the palatability factor or the composition is added to the animal feed alone or in combination with one or more other palatability factors, such as palatability factors of animal and/or vegetable origin.

The palatability factor or the composition forming the object of the invention is preferably used at a rate of 1 to 10% by weight approximately, preferably at a rate of 2 to 4% by weight approximately.

According to a sixth aspect, the present invention relates to using at least one yeast for preparing a palatability factor as mentioned above. The yeast is preferably selected from Yarrowia sp., Saccharomyces sp., Candida sp., Kluyveromyces sp., Pichia sp., Debaryomyces sp., Zygosaccharomyces sp. More preferably, the yeast is selected from Yarrowia lipolytica, Saccharomyces cerevisiae, Candida versalitis, Kluyveromyces lactis, Kluyveromyces fragilis, Pichia pastoris, Debaryomyces harsenii, Zygosaccharomyces rouxii. Most preferably, the yeast Yarrowia lipolytica is used.

According to a seventh aspect, the invention is directed to the use of a palatability factor or a composition according to the invention, for improving the palatability of animal feed.

The present invention likewise divulges a foodstuff for animals comprising at least one palatability factor or at least one composition as described hereinabove. In particular, the palatability factor or the composition is applied to and/or incorporated in said food, preferably at a rate of 1 to 10% by weight approximately, preferably still at a rate of 2 to 4% by weight approximately.

The following figures are intended to illustrate the present invention without limiting it:

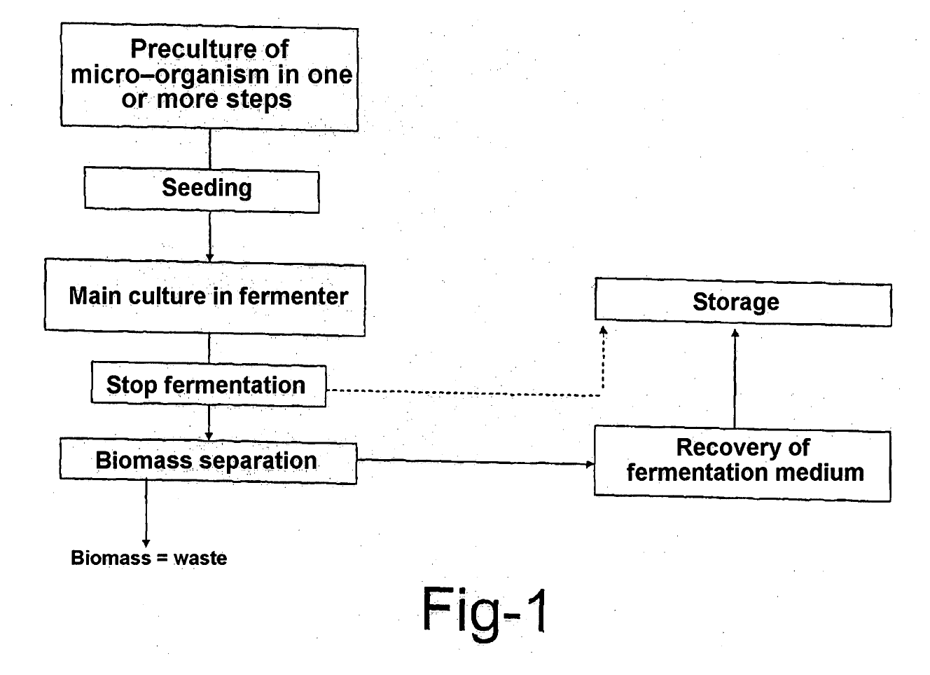

FIG. 1 illustrates an example of the general preparation method of a palatability factor according to the invention;

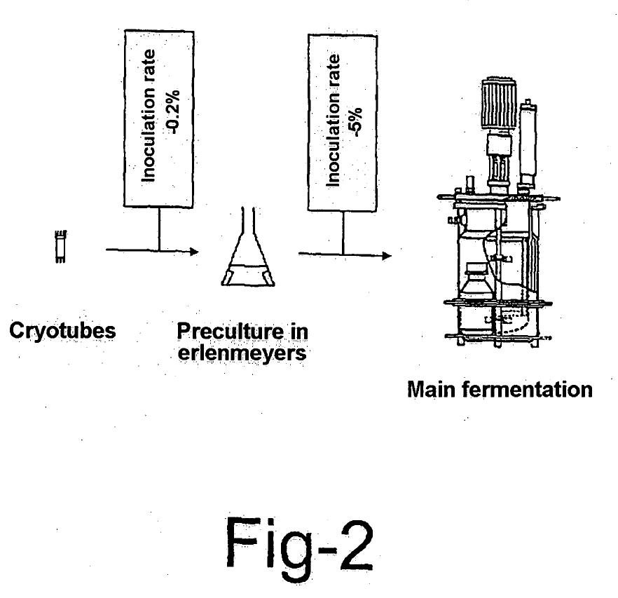

FIG. 2 illustrates an example of the preparation method of a palatability factor according to the invention, en laboratory (examples 1 to 4);

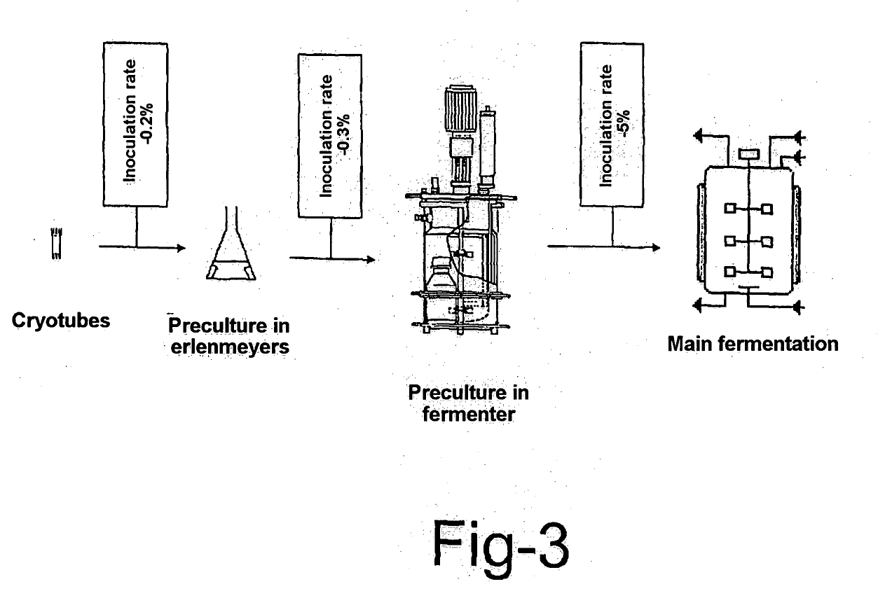

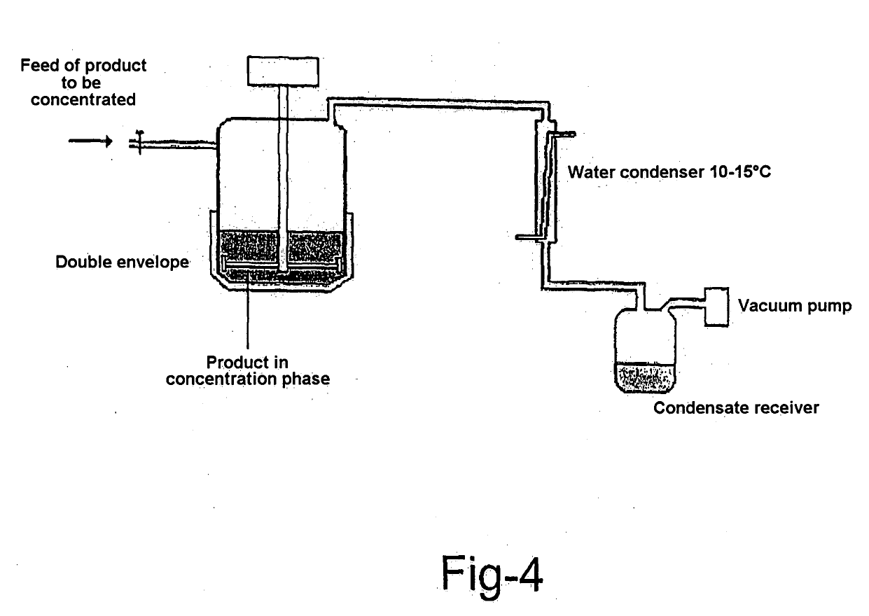

FIG. 3 illustrates an example of the preparation method of a palatability factor according to the invention, applicable on an industrial scale (example 5);

FIG. 4 illustrates an example of the concentration method of a palatability factor according to the invention (example 7);

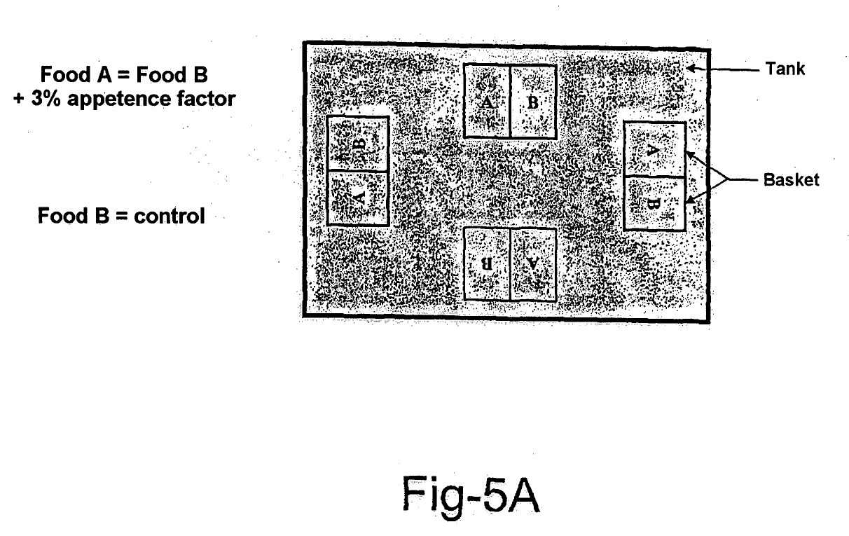

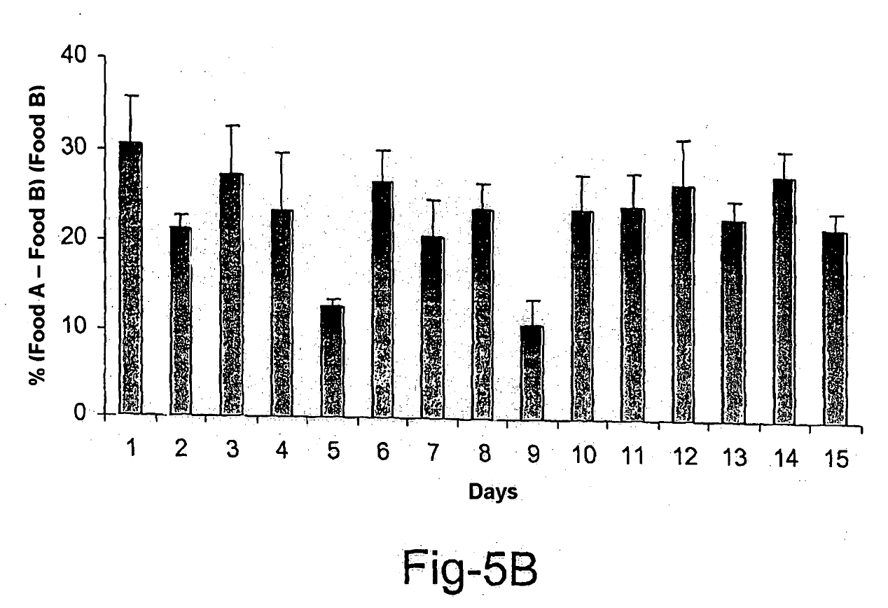

FIG. 5 illustrates the results of a palatability test of a factor according to the invention incorporated in food for shrimp (example 11). A: distribution of baskets in the tank; B: results of the palatability test.

The examples herein below, given purely by way of indication, are intended to illustrate embodiments and advantages of the present invention.

### EXAMPLES

### I—Examples of Palatability Factors Prepared on a Laboratory Scale

A general preparation method is illustrated in FIG. 2.

### 1-1—Example 1

### Utilisation of the Yeast Yarrowia lipolytica and Fermentation in the Presence of Methionine

The first step was the preculture in Yarrowia lipolytica in erlenmeyers containing 100 ml of sterile medium of the following composition: 0.25 gr of malt extract (Muntons—UK), 0.2 gr yeast extract (Biospringer—France), and 1.5 gr of glucose (Merck, Germany), sqf 100 ml of demineralised water. Inoculation was carried out under a sterile hood from cryotubes of 1.8 ml, kept at −80° C. and originating from cultures on standard YM medium with an additional 50% of glycerol content 30%. The theoretical population of the cryotubes was 6.5.10⁷ cells/ml. The pH was adjusted at the start of growth to 5.6 with hydrochloric acid (Merck), the erlens placed on a Novotron agitation table (INFORS, Bottmingen, Switzerland) at 30° C. and at 140 tr/min. Preculture was stopped 16h of incubation. At the same time, the principal fermentation step was prepared. For this, a 5 L glass-vat fermenter (Prelude—GUERIN SA—France) containing 28 gr of malt extract (Muntons—UK), 12 gr yeast extract Biospringer—France), 3.4 gr of H₃PO₄ 75% (Brenntag—France), 150 gr of methionine (Adisseo—France), 5 ml of antimousse (Struktol SB2020) and sqf 5 L of demineralised water, was autoclaved at 121° C.-15 min. After the autoclave, the fermenter was equipped with a gas exit condenser and water circuit glycolised at 2° C., and the medium taken to 30° C. Aeration was fixed at 0.1 l/min due to the mass flow meter on the foodation of the tank bottom sparger. Agitation was 500 tr/min, and temperature regulation fixed at 30° C. The fermenter was inoculated sterile with the preculture (250 ml) such that the population at the beginning of fermentation was at least 1.10⁵ cells/ml. Fermentation was carried out for 48 h. The fermenter was hermetically sealed prior to being placed in the autoclave for inactivation at 110C.°-10 min. After cooling, the fermentation medium was taken out of the fermenter. 30 gr of potassium sorbate 50% (Nutrinova—Germany) then 47 gr of phosphoric acid at 75% were added in under agitation. The final composition of the product was as follows: Humidity: 94.3%, Protein (N×6.25) Kjeldhal: 3.5%, MG by hydrolysis: <1.0%, Soluble sugars Total: 0.62%, Ashes: 1.64%, pH was 2.9.

### 1-2—Example 2

### Other Example for using Yarrowia lipolytica Yeast and Fermentation in the Presence of Methionine

This example was conducted in the same conditions as those of example 1-1, and only the composition of the medium for the main fermentation was different. This contained 22 gr of malt extract (Muntons—UK), 15 gr of yeast extract (Biospringer—France), 3.1 gr of H₃PO₄ 75% (Brenntag—France), 150 gr of Methionine (Adisseo, France), 5 ml of antimousse (Struktol SB2020), 180 gr of anhydrous milk fat (Beuralia, France) and sqf 4 L of demineralised water.

The final composition of the product was as follows: humidity: 90.3%, protein (N×6.25):3.4%, MG by hydrolysis: 4.5%, soluble sugars total: 0.7%, ashes: 1, 7. The pH was 2.9.

### 1-3—Example 3

### Use of Saccharomyces cerevisiae Yeast and Fermentation in the Presence of Methionine

This example was processed in the same conditions as those of example 1, with a different preculture since the yeast utilised was Saccharomyces cerevisiae. The medium was made up of 0.3 gr of malt extract (Muntons—UK), 0.3 gr of yeast extract (Biospringer—France), 0.5 gr of meat peptone (Merck, Germany) and 12.5 gr of glucose (Merck, Germany). The preculture, whereof the pH was adjusted to 5.6, was maintained for 13 h at 30° C.-140 tr/ml. The main fermentation was carried out in the same conditions as in example 1. The composition of the final product was Humidity: 94.9%, Protein (N×6.25) Kjeldhal: 3.8%, MG by hydrolysis: <1.0%, Soluble sugars Total: 0.45%, Ashes: 1.3%, pH was 3.

### 1-4—Example 4

### Utilisation of the Yeast Zygosaccharomyces rouxii and Fermentation in the Presence of Cystein

The yeast Zygosaccharomyces rouxii was cultivated on medium preculture made up of 0.3 gr of malt extract (Muntons—UK), 0.3 gr of yeast extract (Biospringer, France), 0.5 gr of meat peptone (Merck, Germany) and 15 gr of glucose (Merck, Germany). The preculture, whereof the pH was adjusted to 5.6, was maintained 21 h at 30° C.-140 tr/min. The main fermentation was carried out in the same conditions as in example 1, but the composition of the fermentation medium was as follows: 35 gr of malt extract (Muntons—UK), 18 gr of yeast extract (Biospringer, France), 15.6 gr of NaOH 2M (Merck, Germany), 413 gr of Monohydrated Cysteine HCl (AMC-UK), 5 ml of antimousse (Struktol SB2020) and sqf 5 L of demineralised water. The composition of the final product was: Humidity: 88.2%, Protein (N×6.25) Kjeldhal: 7.1%, MG by hydrolysis: <1.0%, Soluble sugars Total: 0.83%, Ashes: 4.3%, pH was 2.9.

### II—Example 5

### Palatability Factor Prepared on an Industrial Scale using Yarrowia lipolytica Yeast, by Fermentation in the Presence of Methionine

The sketch of FIG. 3 illustrates an example of the preparation method applicable on an industrial scale. The first step was identical to that of example 1.15 ml of the preculture were taken sterile and served as inoculum to a sterile medium contained in a 5 L fermenter (Prelude—GUERIN SA, France) containing 15 gr of malt extract (Muntons—UK), 15 gr of yeast extract (Biospringer—France), 50 gr of dextrose monohydrate (Tate & LyIe, Belgium), 12 gr of H₃PO₄ 75% (Brenntag-France, 5 ml of antimousse (Struktol SB2020) and sqf 5 L of demineralised water. The temperature was 30° C.; aeration was fixed at 5 L/min, and agitation at 700 rpm. Fermentation was continued for 12 h. During this time, a fermenter of 60 L capacity (Fermenteur Semi-Automatique Pierre Guerin Biolafitte Type “S” 60/100 L) was fitted. It contained 300 gr of malt extract, 180 gr of yeast extract, 152 gr of phosphoric acid 75%, 2.4 kg of methionine, 80 gr of antimousse Struktol and sqf of demineralised water for a total volume of 60 L. The medium was sterilised at 121° C. for 20 minutes. After cooling to 30° C., the pH was adjusted to 5.7, and an open pressure of 0.5 bars was set, with aeration of 24 L/min. The air output condenser was started up at the 2° C. set point. Inoculation was done sterile with 3 litres of inoculum directly from the 5 L fermenter by means of a peristaltic pump (4 L/h). After 5 h of fermentation, aeration was lowered to 6 L min. Fermentation was thus maintained to a total time of 48 h. Inactivation was done at 110° C.-10 min in the fermenter. Once the temperature dropped below 40° C., 360 gr of potassium sorbate at 50% and 542 gr of phosphoric acid. 75% were added. The fermentation medium was removed from the fermenter and stored in 25-kg coolers at room temperature. The composition of the product was similar to that of example 1.

### III—Examples of Particular Treatments

### III-1—Example 6

### Illustration of a Method in which the Biomass is Eliminated after Fermentation

The product originating from example 1 was treated so as to clear it of micro-organisms and to create a perfectly clear and translucid product. To do this, a filtration system supplied by PALL, France, a K80 type cellulose acetate support, was made use of at the outlet of the 100 L fermenter. The surface of the filter was 0.2 m² The rate was 300 L/h/m². Retention on the filter was 0.2% of dry matter. The assay produced a limpid product, having the following composition: Humidity: 95.8%, Protein (N×6.25) Kjeldhal: 3.05%, MG by hydrolysis: <1.0%, Soluble sugars Total: 0.41% and Ashes: 0.75%.

### III-2 Example 7

### Preparation of a Liquid Concentrated Palatability Factor

An appetent product having stronger dry matter for storage amenities was made. 36 kg of the product originating from example 1 were used in a vacuum concentration method illustrated in FIG. 4. The concentrator was an AURIOL concentrator, of 50 L capacity, 20 L useful capacity (continuous feed). The temperature of the double envelope was fixed at 40° C., for a product temperature of 35° C. A network of water cooled to 10° C. ensured condensation of the evaporated water. The vacuum was fixed at the maximum (35 mbars). The product feed was done manually, at an average of 50 L/h. The concentration was stopped to obtain a concentrated though still fluid product. 4.5 kg of product were obtained, of dry matter equal to 27.5%. The pH was 3.3.

### III-3—Example 8

### Preparation of a Dehydrated Concentrated Palatability Factor

A powder was made on Alfa-Laval type S18 original equipment from the product originating from example 1, with capacity of 20 to 40 kg of evaporated water/h. 15 kg of liquid palatability factor were mixed using an ultraturax. T50 for 5 minutes with 6.4 kg of beer yeast (Lorenzetti, Brazil). Drying took 47 min, input temperature 165° C., output temperature powder 90° C., resulted in 4.4 kg of powder, and humidity of 6%.

### IV—Palatability Tests of a Factor Example According to the Invention

### IV-1—Example 9

### Example of a Factor Applied by Pulverisation on Dog Food

Application of the palatability factor originating from example 1 was done in the form of pulverisation of the liquid, per “batch”, by means of a Forberg type RVC 120 coater.

25 kg of croquettes standard for dogs were placed at 25° C. in the Forberg. 1662 kg of lard fat heated to 60° C. were pulverised by spraying on the croquettes for 50 seconds. Mixing was carried out for 1 minute. Then 1108 kg of palatability factor heated to 30° C. were pulverised by spraying, for 60 seconds. The mixture was maintained for another 1 minute. The coated croquettes were drained and packaged to be transported to the test structure. Codification was completed during batch coating, and appeared on the bags. Product A was coated with the palatability factor originating from example 1. Product B was the check sample (coating with a meat-based palatability factor, from the super-premium range of the company SPF, France). The coating conditions for the check sample were identical to those described for obtaining product A.

The palatability of the resulting food was measured inside the PANELIS, France structure, in an expert panel, and according to a versus test method. 2 meals were distributed over a day to 36 dogs. 2 foodstuffs were presented to each animal simultaneously, each food labelled A or B adequately covering the nutritional needs of each animal, with their position being inverse (right or left) from one meal to the other to avoid choice by lateralisation. The first foodstuff towards which the animal moved (first choice) was recorded with the final consumption of each foodstuff. The results are expressed in % relative to consumption of A or B. The results were treated statistically (Test ChI² for the first choice and student test for the consumption ratio). Only the “valid” dogs which ate normally were included. The results summarised in table 1 show that the food coated with the palatability factor originating from example 1 are preferred over the au check sample by the dogs.

TABLE 1

| | First | Consumption | Student |
|---|---|---|---|
| | Choice | Ratio | Test |
| Test | Test Chi² | (% relative) | Ratio |
| Meal 1 | | | |
| Product A | 17.06 *** | 84 | *** |
| Check sample - | | 16 | |
| Meal 2 | | | |
| Product A | 11.65 *** | 78 | *** |
| Check sample - | | 22 | |

*** Very high significance (p < 0.01)

### IV-2—Example 10

### Example of a Palatability Factor Incorporated into Dog and Cat Food

Using the palatability factor originating from example 1 was done “by inclusion” in a base standard for dog food or a base standard for cat food during extrusion at 10% of the total weight of the base food. Extrusion was carried out using a dual-screw corotative Evolum 53 extruder CLEXTRAL (France).

The food A-CT was the cat food containing 10% of the palatability factor. It was coated by chicken fat heated to 45° C. at 6% in the Forberg type RVC 120, at 25° C. The food A-CN was the dog food containing 10% of the palatability factor. It was coated by lard heated to 60° C. at 6% in the Forberg type RVC 120, at 25° C. The T-CT and T-CN foods were the dry food check samples without inclusion of palatability factor respectively, but coated with fat as specified hereinabove. The same quantity of this food was utilised in a second series, though this time with an external coating of a palatability factor Super-Premium SPF based on animal proteins, at 30° C., in the Forberg type RVC 120, at 25° C., in conditions equivalent to those of example 9. The batches of this second series were labelled Food A-CT-E, Food A-CN-E, Food T-CT-E and Food T-CN-E.

The palatability of the resulting food was measured inside the structure PANELIS, France, in an expert panel, and according to a versus test method. 2 meals were distributed over a day to 36 dogs, or over 2 days to groups of 40 cats. The tests were conducted with analyses in the same conditions as those described in example 9. The results summarised in table 2 show that the food containing the palatability factor originating from example 1 is preferred over the check samples by dogs and cats.

TABLE 2

| | | First | Consumption | Student |
|---|---|---|---|---|
| | | Choice | Ratio | Test Ratio |
| Panel | Test | Test | (% relative) | Threshold |
| Cattery | Meal 1 | | | |
| Series 1 | Food A-CT | nd | 59 | * |
| | Food T-CT | | 41 | |
| | Meal 2 | | | |
| | Food A-CT | nd | 57 | * |
| | Food T-CT | | 43 | |
| Cattery | Meal 1 | | | |
| Series 2 | Food A-CT- | nd | 68 | ** |
| | Food T-CT | | 31 | |
| | Meal 2 | | | |
| | Food A-CT- | nd | 61 | * |
| | Food T-CT | | 33 | |
| Kennel | Meal 1 | | | |
| Series 1 | Food A-CN | 16.20 | 91 | *** |
| | Food T-CN | | 9 | |
| | Meal 2 | | | |
| | Food A-CN | 9.14 ** | 84 | *** |
| | Food T-CN | | 16 | |
| Kennel | Meal 1 | | | |
| Series 2 | Food A-CN- | 5.45 * | 75 | ** |
| | Food T-CN- | | 25 | |
| | Meal 2 | | | |
| | Food A-CN- | 4.80 * | 70 | * |
| | Food T-CN- | | 30 | |

*** Very high Significance (p < 0.01)
** High Significance (p < 0.05)
* Significance (p < 0.1)
( ) Not significant

### IV-3—Example 11

### Example of a Palatability Factor Incorporated into Shrimp Food

The palatability factor originating from example 1 was incorporated by inclusion at 3% into a food of commercial type having the following formula: fish flour 40%, whole wheat 25%, wheat feed 15%, soy oilmeals 9.5%, shrimp flour 6%, fish oil 2%, soya lecithin 1%, vitamin mixture 1% and mineral mixture 0.5%. The food (food A) obtained by pressing on a Hobart press (Germany) was compared to a food of identical formula, but without palatability factor (food B=control).

The assays were conducted on the P. vanamei species of shrimp from a fish farm (Brazil) in a tank of 1000 m². The average weight of the shrimps was 8g and the density was 20 animals/m². The shrimps were nourished by means of 4 baskets placed at precise points in the tank. Each basket was separated into two parts on which the feeding A and B took place. FIG. 5A illustrates the distribution of the baskets in the tank. Each food was arranged in the baskets at 4% of the biomass per day, in two distributions spread out over the day. The food was placed on the baskets early in the morning and afternoon, and the baskets were raised late morning and afternoon for quantification of the not yet eaten by the shrimps. These steps were repeated every day for a fortnight.

The following parameter was calculated for each test day: [(Food A ingested−Food B ingested)/Food B ingested]*100. The results are presented in FIG. 5B.

On completion of 2 weeks of testing, the consumption of food A containing the palatability factor was 23% higher than that of food B without palatability factor. Food A containing the palatability factor was significantly preferred to food B (P<0.05).

### V—Example 12

### Composition of Palatability Factors

A palatability factor was prepared by mixing the product originating from example 1 with a Super Premium palatability factor based on animal proteins. The proportions of the mixtures are summarised in table 3. The mixtures were done using an Ultraturax T50 disperser mixer.

TABLE 3

| | Proportion of | Proportion of |
|---|---|---|
| | palatability | palatability factor |
| | factor example 1 | based on animal |
| Mixture No. | (%) | proteins (%) |
| 1 | 10 | 90 |
| 2 | 20 | 80 |
| 3 | 33 | 66 |
| 4 | 50 | 50 |

Food for dogs was made by spraying mixtures onto base croquettes in Forberg type RVC 120. 24.955 kg of croquettes standard for dogs were placed at 25° C. in the Forberg. 1654 kg of lard fat heated to 60° C. were pulverised by spraying onto the croquettes for 50 seconds. Mixing was done for 1 minute. Then 831 grams of palatability factor heated to 30° C. were pulverised by spraying, for 60 seconds. Mixing was continued for another minute. The coated croquettes were drained and packaged in gabs to be transported to the test structure. The check sample was the food coated with the meat-based palatability factor alone having served as mixture, originating from the super-premium range of the company SPF (France) and under the same conditions. The palatability of food thus obtained was measured inside the structure PANELIS, France, under the conditions described in example 9. The results summarised in table 4 show that the palatability factors constituted by the mixtures make the food on which they are sprayed more appetising than the check samples.

TABLE 4

| | Consumption | Student |
|---|---|---|
| Test | Ratio | Test Ratio |
| Meal 1 | | |
| Food mix 1 | 60 | ** |
| Check sample | 40 | |
| Meal 2 | | |
| Food mix 1 | 58 | |
| Check sample | 41 | |
| Meal 1 | | |
| Food mix 2 | 68 | * |
| Check sample | 32 | |
| Meal 2 | | |
| Food mix 2 | 72 | ** |
| Check sample | 41 | |
| Meal 1 | | |
| Food mix 3 | 75 | ** |
| Check sample | 25 | |
| Meal 2 | | |
| Food mix 3 | 70 | |
| Check sample | 30 | ** |
| Meal 1 | | |
| Food mix 4 | 76 | *** |
| Check sample | 24 | |
| Meal 2 | | |
| Food mix 4 | 75 | ** |
| Check sample | 25 | |

*** Very high Significance (p < 0.01)
** High Significance (p < 0.05)
* Significance (p < 0.1)
( ) Not significant

1. A fermented palatability factor to be added to animal feed, wherein it comprises the fermentation medium obtained after culture of at least one yeast, said fermentation medium containing at least:
humidity (H): from 80 to 96% by weight approximately;
protein factor (FP): from 1.5 to 10.0% by weight approximately;
fatty matter (MG): up to 10% by weight approximately;
sugars (S): from 0.20 to 2.0% by weight approximately; and
ashes (C): from 0.3 to 8.0% by weight approximately,
wherein said protein factor (FP) is devoid of constituents of animal origin.

2. The palatability factor according to claim 1, wherein said constituents of said protein factor (FP) are selected from the group consisting of proteins, peptides, amino acids, and their combinations.

3. The palatability factor according to claim 2, wherein said protein factor (FP) comprises at least 90% by weight approximately of one or more amino acids selected from the group consisting of alanine, threonine, lysine, and sulphured amino acids.

4. The palatability factor according to claim 3, wherein said protein factor (FP) comprises at least 95% by weight approximately of said amino acids.

5. The palatability factor according to claim 3, wherein said sulphured amino acids are selected from the group consisting of methionine and cystein.

6. The palatability factor according to claim 1, wherein it has a pH ranging from 1.6 to 3.5 approximately.

7. The palatability factor according to claim 1, wherein said yeast is selected from the group consisting of Yarrowia sp., Saccharomyces sp, Candida sp., Kluyveromyces sp., Pichia sp., Debaryomyces sp., and Zygosaccharomyces sp.

8. The palatability factor according to claim 7, wherein said yeast is selected from the group consisting of Yarrowia lipolytica, Saccharomyces cerevisiae, Candida versalitis, Kluyveromyces lactis, Kluyveromyces fragilis, Pichia pastoris, Debaryomyces harsenii, and Zygosaccharomyces rouxii.

9. The palatability factor according to claim 8, wherein said yeast is Yarrowia lipolytica.

10. The palatability factor according to claim 1, wherein it is in liquid form ready for use.

11. The palatability factor according to claim 1, as an intermediary product in the preparation of a concentrated fermented palatability factor.

12. The palatability factor according to claim 1, wherein it is applied to and/or incorporated in said animal feed.

13. The palatability factor according to claim 12, wherein it is utilised in association with one or more other palatability factors.

14. The palatability factor according to claim 12, wherein it is utilised at a rate of 1 to 10% by weight approximately.

15. The palatability factor according to claim 1, wherein said animal feed is intended for pets.

16. A concentrated fermented palatability factor to be obtained by concentration and/or dehydration of at least one palatability factor according to claim 1.

17. Composition of palatability factors to be added to animal feed, wherein it comprises at least one palatability factor according to claim 1.

18. A method for preparing a palatability factor according to claim 1, wherein said method comprises at least the following steps:
a) preculture of at least one yeast in standard growth medium, at a temperature ranging from 22° C. to 32° C. approximately, for 6 to 25 hours approximately;
b) seeding of a fermentation medium containing one or more amino acids, by means of said preculture at a rate of at least 1.10⁵ cells/ml approximately;
c) culture of the seeded fermentation medium for 12 to 72 hours approximately, at a temperature ranging from 20° C. to 32° C. approximately;
d) termination of fermentation; and
e) recovery of the final fermentation medium useful as palatability factor.

19. The method according to claim 18, wherein the fermentation medium utilised in step b) comprises approximately 2 to 10% by weight, of one or more amino acids.

20. The method according to claim 19, wherein said amino acids are selected from the group consisting of alanine, threonine, lysine, sulphured amino acids.

21. The method according to claim 18, wherein step d) is carried out by thermal inactivation of yeasts.

22. The method according to claim 18, wherein, prior to step e), said fermentation medium is stripped of the biomass.

23. The method according to claim 22, wherein the steps d) to e) are carried out simultaneously.

24. A method for improving the palatability of animal feed, wherein said method comprises adding at least one palatability factor according to claim 1 to said animal feed.

25-26. (canceled)

27. The method according to claim 23, wherein said steps d) to e) are carried out by sterilizing filtration.

28. A method for improving the palatability of animal feed, wherein said method comprises adding at least one composition according to claim 17 to said animal feed.
